(19) United States
(12) Patent Application Publication
(10) Pub. No.: US 2019/0282843 A1
(43) Pub. Date: Sep. 19, 2019

(54) PREVENTING FIRE IN WOOD PRODUCTION BLENDER

(71) Applicant: T.I.P. The Industry Pivot Ltd., Caesarea (IL)

(72) Inventor: Amnon Shoshani, Givat Ada (IL)

(73) Assignee: T.I.P. The Industry Pivot Ltd., Caesarea (IL)

(21) Appl. No.: 15/924,754

(22) Filed: Mar. 19, 2018

(51) Int. Cl. A62C 3/06; A62C 37/44; A62C 37/36; B27N 9/00

(52) U.S. Cl. CPC A62C 3/06; B27N 9/00; A62C 37/04; A62C 37/44

(57) ABSTRACT

Apparatus includes a fire prevention system having a dispenser of a fire extinguishing substance, a blender operative to blend a mixture of wood particles, and one or more conduits located inside the blender. The one or more conduits are in fluid communication with a source of water and a source of wax. The fire prevention system is in fluid communication with the blender and the one or more conduits for dispensing the fire extinguishing substance into the blender or one or more conduits.

### FIELD OF THE INVENTION

The present invention relates generally to prevention of fire in wood production, and particularly to prevention of fire in a wood production blender.

### BACKGROUND OF THE INVENTION

Wood manufacturing facilities manufacture wood from strands, particles, flakes, wafers, chips, powder and the like, e.g., particleboard (PB), oriented strandboard (OSB), strawboard and others, can pose serious fire hazards. The wood particles are typically coated with an adhesive resin, wax and/or chemicals and then formed into a mat for compression and curing to produce a board. The adhesive resin, wax and/or chemicals are typically mixed with the wood particles in a rotary drum blender or another type of blending device.

Combustible dust explosions can occur as the result of an accumulation of fine, powder-like combustible dust, dispersion of the dust into the air in sufficient amounts, the presence of oxygen in the air, and an ignition source, such as a flame, spark or just the high temperature of the processing technique.

In wood board production, the blender particularly poses a fire hazard, mainly due to the presence of dispersed dry wood particles and inflammable or dangerous chemicals (such as the resins or other chemicals). Many fires start before the process enters the blender and the fire then continues into the blender (particularly for strands and other particles).

The blender is not something firefighters can easily enter and significant procedures must be taken before entering or opening a blender. Such procedures take time, allowing fires to spread. Furthermore, in the prior art, in the event of a fire, the blender is often shut down to prevent the fire from spreading further. Installation of fire extinguishing spray nozzles in the blender is not possible or impractical because they get coated or clogged quickly by the resin and or other materials in the blender and become inoperable.

### SUMMARY OF THE INVENTION

The present invention seeks to provide methods and apparatus for prevention of fire in a wood production blender.

There is thus provided in accordance with an embodiment of the present invention apparatus including one or more conduits in fluid communication with a source of water and a source of wax, one or more conduits located inside the blender, a blender operative to blend a mixture of wood particles, and one or more fire hazard sensors in operative communication with a controller, wherein upon detection of a fire hazard by the one or more fire hazard sensors, the controller is operative to permit discharge of water from the one or more conduits into the blender and shut off discharge of wax from the one or more conduits into the blender. The control of discharge of water or other fire extinguishing material may be manual, semi-automatic or automatic, such as but not limited to, operation by remote control, from an operating console, via the Internet, etc.

In accordance with an embodiment of the present invention the controller is operative to discharge water into the blender via one or more additional conduits. For example, the one or more additional conduits may be normally in fluid communication with an adhesive.

In accordance with an embodiment of the present invention the one or more fire hazard sensors include one or more fire or smoke detectors located inside or in a vicinity of the blender. Alternatively or additionally, the one or more fire hazard sensors may include a temperature sensor and/or an infrared (IFR) and/or a near infrared (NIR) sensor that senses a rise in temperature above a safe threshold. Alternatively or additionally, the one or more fire hazard sensors may include a chemical sensor that senses a change in chemical composition of a blender atmosphere above a safe threshold. Alternatively or additionally, the one or more fire hazard sensors may include a sound or ultrasound sensor that senses a change in sound in the blender as a result of a fire.

In accordance with an embodiment of the present invention fire extinguishing substances may be added to the water.

There is provided in accordance with an embodiment of the present invention a method including providing one or more conduits located inside a blender which is operative to blend a mixture of wood particles, the one or more conduits being in fluid communication with a source of water and a source of wax, and upon detection of a fire hazard by one or more fire hazard sensors, causing discharge of water from the one or more conduits into the blender and shutting off discharge of wax from the one or more conduits into the blender.

### BRIEF DESCRIPTION OF THE DRAWINGS

The present invention will be understood and appreciated more fully from the following detailed description taken in conjunction with the drawing in which:

FIG. 1 is a simplified block diagram of a method and apparatus for prevention of fire in a wood production blender, in accordance with an embodiment of the present invention.

### DETAILED DESCRIPTION OF THE PREFERRED EMBODIMENT

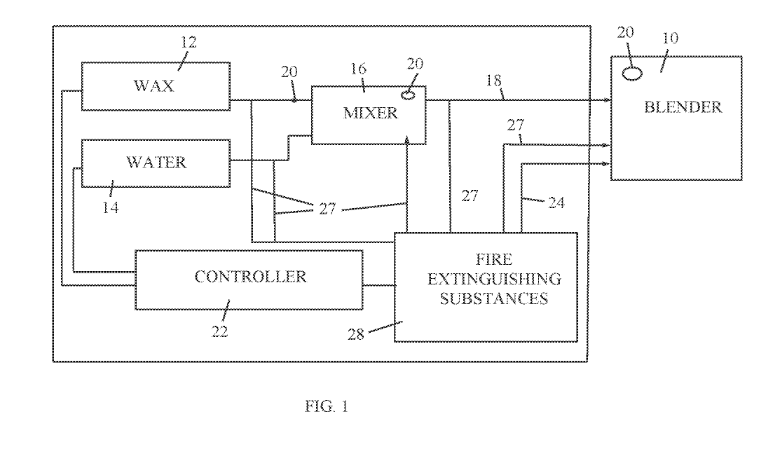

Reference is now made to FIG. 1, which illustrates a method and apparatus for prevention of fire in a wood production blender, in accordance with an embodiment of the present invention.

In the production of many wood products, a water-wax mixture (e.g., suspension, emulsion, dispersion, solution, etc.) is introduced into a wood slurry (mixture of wood particles, resin, chemicals and/or water) in a blender 10. The water-wax mixture may be created by mixing wax from a wax source 12 with water from a water source 14. The water-wax mixture may be mixed by a mixer 16 and then introduced into blender 10 by one or more conduits (such as, but not limited to, spray nozzles) 18 located inside blender 10, as seen in FIG. 1. The system works continuously so the conduits 18 do not get clogged.

In accordance with an embodiment of the present invention, a fire prevention system is added to the wood production system. The fire prevention system is designed to extinguish fires that may originate in conduits and such that lead to the mixer or blender, or to extinguish fires that may occur in the mixer or blender. The fire prevention system dispenses one or more kinds of fire extinguishing substances through one or more fire extinguishing conduits 27 in order to extinguish the fire. The term “fire extinguishing substance” includes not only water, such as the water from water source 14 or water from an additional water source, but any other fire extinguishing material, solid, liquid, or gas. Accordingly, the fire extinguishing substance may be dispensed from water source 14 and/or from a dedicated fire extinguishing substance source (reservoir) 28 or an external source.

The fire extinguishing substance may be dispensed manually from the fire prevention system, such as by means of suitable valves. Alternatively, the fire prevention system may also include one or more fire hazard sensors 20 that detect the presence of a fire hazard. For example, sensor 20 can be a fire or smoke detector located inside or in the vicinity of blender 10. In other examples, sensor 20 may be a temperature sensor that senses a rise in temperature above a safe threshold or a chemical sensor that senses a change in chemical composition of the blender atmosphere above a safe threshold. Sensor or sensors 20 are in communication with a controller 22, which controls the flow of wax, water and fire extinguishing substances.

Upon detection of a fire hazard, as detected by the one or more sensors 20, controller 22 immediately shuts off flow of wax (e.g., by closing a valve to prevent flow of wax to the mixer or to the blender), and discharges fire extinguishing substances (from water source 14 and/or fire extinguishing substance source 28), either into conduits that are upstream of the mixer 16, downstream of the mixer 16 (conduits that lead into the blender 10) or into the blender 10 itself. For example, the controller 22 may permit only discharge of water or other fire extinguishing substances from conduits 18 into blender 10 (and may optionally increase the flow of water from water source 14). The quick spraying of water can reduce the risk of fire and extinguish a fire that has started. In addition, water or other fire extinguishing substances can be sprayed through adhesive nozzles 24 (that is, conduits that normally introduce adhesives into the blender) and/or from one or more separate conduits 27. Fire extinguishing substances 28 can be added to the water (such as, but not limited to, potassium acetate, potassium carbonate, potassium citrate, or foams, such as aqueous film-forming foam, and many others). As mentioned before, the same conduits can be used to introduce solid, liquid or gas fire extinguishing materials. In some cases, conduits 18 or spray nozzles 24 may be nozzles in which compressed air flows together with or adjacent to other substances which are introduced through the conduits or nozzles. Additionally or alternatively, fire extinguishing substances 28 can be added through such compressed air paths.

What is claimed is:

1. Apparatus comprising:
a fire prevention system comprising a dispenser of a fire extinguishing substance;
a blender operative to blend a mixture of wood particles; and
one or more conduits located inside said blender, said one or more conduits in fluid communication with a source of water and/or a source of wax; wherein said fire prevention system is in fluid communication with said blender and said one or more conduits for dispensing said fire extinguishing substance into said blender or said one or more conduits.

2. Apparatus according to claim 1, wherein said fire prevention system comprises one or more fire hazard sensors in operative communication with a controller, wherein upon detection of a fire hazard by said one or more fire hazard sensors, said controller is operative to permit discharge of said fire extinguishing substance into said one or more conduits or into said blender and shut off discharge of wax from said one or more conduits into said blender.

3. Apparatus according to claim 1, wherein said fire extinguishing substance comprises water from said source of water.

4. Apparatus according to claim 1, wherein said controller is operative to discharge said fire extinguishing substance via one or more additional conduits.

5. Apparatus according to claim 4, wherein said one or more additional conduits are normally in fluid communication with an adhesive.

6. Apparatus according to claim 2, wherein said one or more fire hazard sensors comprise one or more fire or smoke detectors located inside or in a vicinity of said blender.

7. Apparatus according to claim 2, wherein said one or more fire hazard sensors comprise a temperature sensor that senses a rise in temperature above a safe threshold.

8. Apparatus according to claim 2, wherein said one or more fire hazard sensors comprise a chemical sensor that senses a change in chemical composition of a blender atmosphere above a safe threshold.

9. Apparatus according to claim 1, wherein said fire extinguishing substance is added to the water from said source of water.

10. A method comprising:
providing one or more conduits located inside a blender which is operative to blend a mixture of wood particles, said one or more conduits being in fluid communication with a source of water and/or a source of wax;
detecting a fire hazard; and
dispensing a fire extinguishing substance into said blender or said one or more conduits with a fire prevention system which is in fluid communication with said blender and said one or more conduits.

11. The method according to claim 10, wherein detecting the fire hazard is done by means of one or more fire hazard sensors.

12. The method according to claim 10, further comprising shutting off discharge of wax from said one or more conduits into said blender.

13. The method according to claim 10, and further causing discharge of said fire extinguishing substance into said blender via one or more additional conduits.

14. The method according to claim 13, wherein said one or more additional conduits are normally in fluid communication with an adhesive.

15. The method according to claim 10, wherein said fire extinguishing substance comprises water from said source of water.
